(19) United States
(12) Patent Application Publication
(10) Pub. No.: US 2016/0243886 A1
(43) Pub. Date: Aug. 25, 2016

(54) DIGITAL IMAGING SCREEN PRINTING PROCESS

(71) Applicant: Nicholas Jon Slette, Arlington, TX (US)

(72) Inventor: Nicholas Jon Slette, Arlington, TX (US)

(21) Appl. No.: 15/052,740

(22) Filed: Feb. 24, 2016

Related U.S. Application Data
(60) Provisional application No. 62/120,193, filed on Feb. 24, 2015.

(51) Int. Cl. B44C 1/17; D21H 19/20; B41M 5/00

(52) U.S. Cl. CPC B44C 1/1712; B41M 5/0023; D21H 19/20

(57) ABSTRACT

A transfer paper substrate for to acceptance of digitally printed color images and the successive single step heat transfer to a fabric is disclosed. The substrate includes a paper having a plastisol mixture applied to a surface followed by a non-adhesive powder applied over the plastisol mixture. The plastisol mixture is a combination of a water reducer and plastisol. Talc powder is used to aid in the mixing of the two substances. Digital images are printed onto the non-adhesive powder. Once printed, a plastisol layer is screened over the image and non-adhesive layer followed by the application of an adhesive powder.

### CLAIM OF PRIORITY

This application claims the benefit of U.S. Provisional Application No. 62/120,193, filed 24 Feb. 2015. The information contained therein is hereby incorporated by reference.

### BACKGROUND

1. Field of the Invention

The present application relates generally to screen printing and digital printing heat transfers, and more particularly to an improved process which combines the techniques of screen printing and digital printing to create a heat transfer.

2. Description of Related Art

Screen printing, by which ink is pressed through a stencil which is supported by a woven mesh to create an image on a substrate, such as a garment of clothing, has been a form of printing for a long time. Screen printing templates typically include multiple colors. The current process for printing a multi-colored image has many disadvantages.

In particular, each color on a template is typically printed with a separate screen. This necessitates a plurality of machines to be used to generate a single image. The result is a multi-stage process which increases time and costs to produce the image. Many of these disadvantages were addressed by the advent of digital printing heat transfers, by which a printer is used to create a digitally printed design onto a heat transferable substrate which is then applied to a garment using heat and pressure. The substrates, however, have limitations, such as the inability to transfer to dark colored garments, the inability to print white or gradients, the need to weed the design before transferring, cracking and peeling of prints, and so forth. The heat transferable substrates are lacking.

An improved substrate transfer paper is needed which leads to a more efficient printing process. Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a transfer paper substrate according to the preferred embodiment of the present application.

FIG. 2 is an exploded side view of the layers of the transfer paper substrate of FIG. 1.

FIG. 3 is a chart of steps taken to make the transfer paper substrate of FIGS. 1 and 2.

FIG. 4 is an exemplary digital image for use in the screen printing using the transfer paper substrate of FIG. 1.

While the substrate and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the methods described herein may be positioned in any desired order. The use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The substrate and method in accordance with the present application overcomes one or more of the above-discussed problems commonly associated with existing printing processes. Specifically, the substrate of the present application is configured to permit the single stage screening process of a multi-colored digital image. The image is transferrable onto a piece of fabric in a single heat transfer step. The image does not need to be weeded afterwards and is not limited in color selection. The present application discloses the characteristics of the heat transferable substrate that is configured to accept a digitally printed image. Furthermore, the substrate herein is configured to permit for a more simplified and efficient method of screen printing. These and other unique features of the system are discussed below and illustrated in the accompanying drawings.

The substrate and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The substrate and method of the present application is illustrated in the associated drawings. The substrate includes multiple layers of various elements configured to accept a printed image. The layers include a plastisol mixture and a coating of non-adhesive powder (i.e. paper mache powder). The image is printed across the powder. Once printed, the substrate is modified to further include additional layers to allow for adhesion to the fabric. An additional plastisol layer is added as well as an adhesive powder. The locating of the image between two layers of plastisol materials allows for the self-weeding characteristic and freedom to use any colors. Additional features and characteristics of the substrate are illustrated and discussed below.

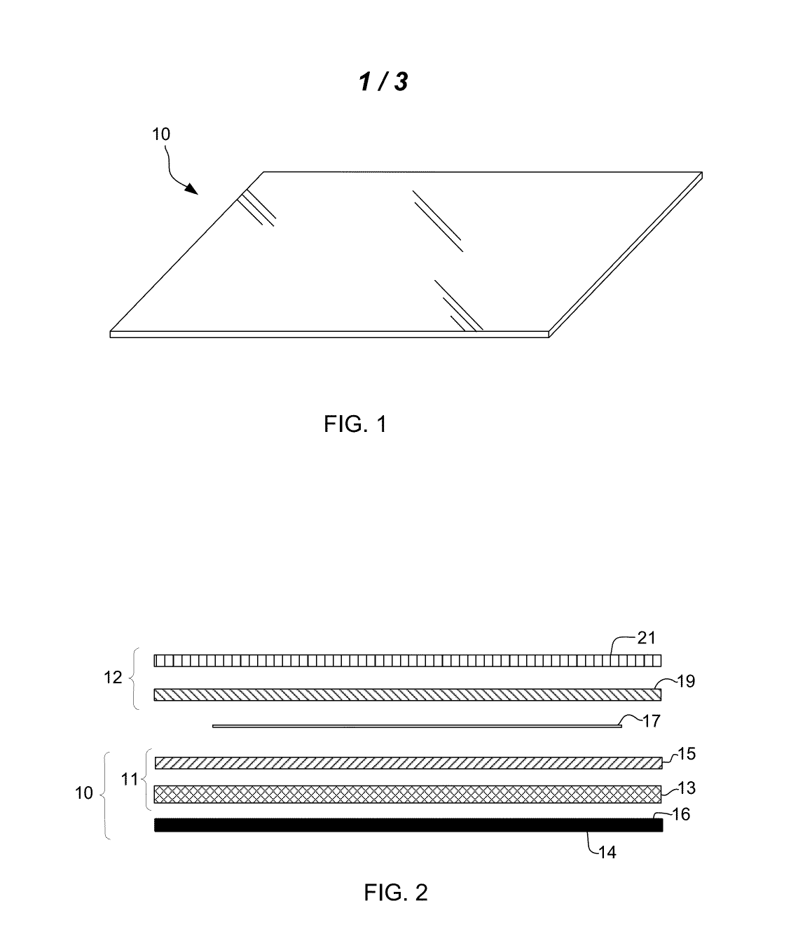

Referring now to the drawings wherein like reference characters identify corresponding or similar elements in form and function throughout the several views. FIGS. 1-2 illustrate transfer paper substrate 10. FIG. 1 provides a perspective view wherein the substrate includes a first stage layer configured to accept a digitally printed image. It is important to note that substrate 10 is illustrated in FIG. 1 is in a condition prepared to accept the image. A second stage layer is applied after printing of the image to allow for the efficient and clean transfer of the image to the fabric. It is an object of the method of this disclosure to utilize substrate 10 to sandwich and locate a digitally printed image 17 between opposing layers of plastisol. Plastisol is used to transfer and adhere the image 17 to the fabric. FIG. 2 illustrates the various stage layers in association with substrate 10.

The system of the present application is configured to include an improved transfer paper substrate 10 to produce a full color, no peel transfer for dark or light colored images. The screen printing process of the present application is configured to use substrate 10 to receive digital color prints and then transfer such prints directly to a fabric material in a single step heating process. The color print/image may utilize one or more colors. Transfer paper substrate 10 is developed for the printing industry, using a combination of digital aqueous inkjet printing and screen printing to produce a full color. It is preferred that the images are printed using a pigment based printer as opposed to a dye based printer.

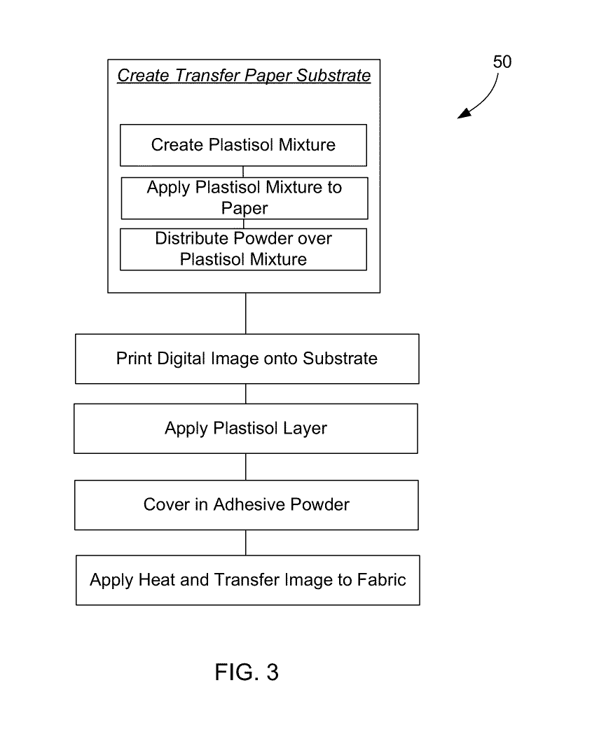

As seen in FIG. 2, substrate 10 is illustrated having the first stage layer 11 and a second stage layer 12. In its base form, substrate 10 includes the first stage layer 11. In this form, substrate 10 is prepared for transportation, sale, and the acceptance of digitally printed images 17. These may be mass produced following a series of steps (see FIG. 3).

Referring also to FIG. 3 in the drawings, a series of steps are illustrated in a chart 50 for the creation and use of substrate 10. Substrate 10 includes first stage layering 11. First stage layering 11 includes a plastisol mixture 13 and a non-adhesive powder 15. Mixture 13 is applied directly to paper 14. Powder 15 is applied over mixture 13, opposite paper 14. Paper 14 may be any type of paper suitable for screen printing in the industry. An example would be standard 20 lb white paper. Alternative colors and weights of paper may be used.

Mixture 13 is a combination of elements mixed together, namely plastisol, a water reducer, and talc powder. Plastisol forms a solid layer when it is heated. The water reducer is used to counteract the hardened nature of plastisol, by weakening the bond of the plastisol. Water reducer is water based and does not normally mix well with plastisol. Talc powder is a solvent and is added to allow both the water reducer and plastisol to mix. The specific mixing ratios may be adjusted to vary the desired results. The idea is to create a weaker bond in the plastisol to allow part of the image to pull off when substrate 10 is removed after the heat press step. Mixture 13 helps provide the characteristic of being self-weeding. The term weeding refers to the extra step needed to remove portions of most conventional digital transfer paper, which is not needed with substrate 10 and the associated screen printing process.

As stated above, a thin coat of mixture 13 is applied to a first surface 16 of paper 14. Mixture 13 may be applied to paper 14 in different ways. For example, mixture 13 may be screen printed onto the paper, but any means that produces a thin smooth plastisol layer may be used. Mixture 13 is flashed at 350 degrees F. for 20 seconds on paper 14. The temperature and time duration may be adjusted and is not herein limiting. At this point, mixture 13 has a tacky feel. Paper 14 and mixture 13 are dusted with powder 15. The excess powder 14 is then removed either with compressed air or by wiping. Substrate 10 is now ready to accept printing. By removing the tacky feel of mixture 13, substrate 10 may be stacked and shipped more easily without fear of damage from sticking.

Once image 17 has been selected and printed onto mixture 13, second stage layer 12 is applied. Layer 12 includes a layer of plastisol 19 and a layer of adhesive powder 21. Plastisol 19 is applied directly over image 17 and over non-adhesive powder 15 where image 17 does not exist. Image 17 is sandwiched between two layers of plastisol or plastisol based materials (items 13 and 19). Powder 15 acts to prevent the bonding of plastisol 19 directly with mixture 13. However, image 17 is in contact with plastisol 19 and mixture 13. Contact with mixture 13 occurs from printing. When paper 14 is removed after the heating process, part of image 17 remains on first stage 11 and substrate 10 in general. Adhesive powder 21 is applied over plastisol 19 and is configured to provide adhesion between plastisol 19, image 17, and the fabric. In order to initiate a transfer of the digital image, substrate 10 with the digital image 17 and layers 11 and 12 are laid over the fabric such that layer 12 is in contact with the fabric. Heat is applied that induces the transfer to the fabric. The paper is removed after a designated time for cooling. The use of powder 15 along with the image between plastisol 19 and mixture 13 allows for the self-weeding characteristic of the screen printed image.

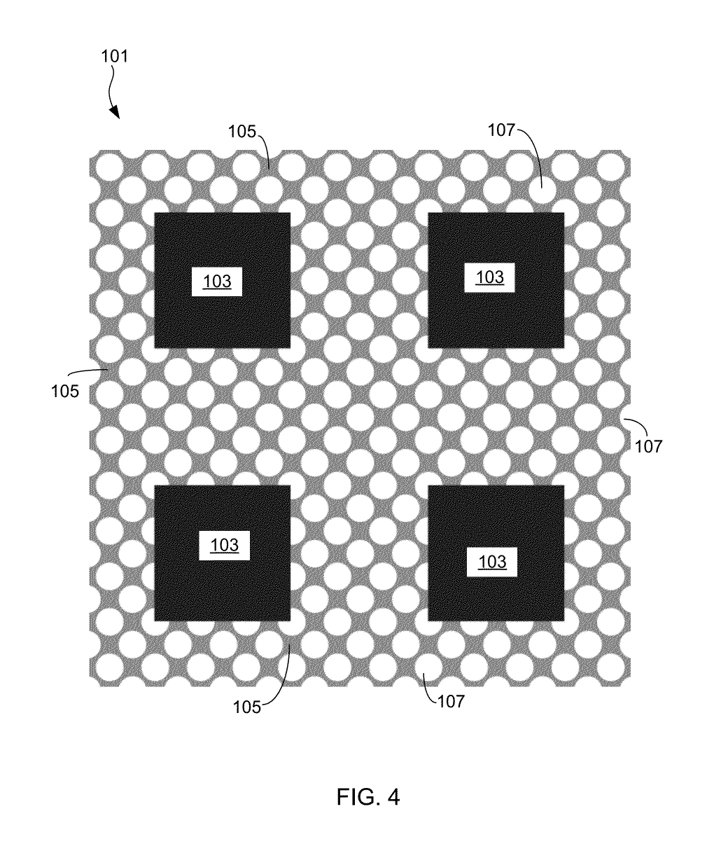

Referring now also to FIG. 4 in the drawings, an exemplary digital image for use with substrate 10 and the digital imaging process herein disclosed is shown. FIG. 4 designates areas that are black (garment) 103, colored 105, and white 107. The white areas are a patterned series of circles laid over a colored 105 background. The image is loaded into design software and printed on substrate 10 across first stage layer 11. The digital image is mirrored so as to print in reverse on substrate 10 to ensure the correct orientation upon transferring. Printing of the digital image may be done in a single process. The digital image may include one or more colors.

Once printed, second stage layer 12 is applied to substrate 10 and the digital image. This may be applied as follows: substrate 10 is aligned with the digitally printed image onto a template. The plastisol layer 19 is screened onto first stage layer 11 and the digital image. The digital image print is now sandwiched between two layers of plastisol. The plastisol does not adhere to the powder 13 and will not transfer at those areas. Taping may be used to secure substrate 10 in the template.

Substrate 10 is removed from the screen. The new plastisol layer is covered with an adhesive powder 21. Excessive or excess powder is to be removed. Compressed air may be used to remove any remaining adhesive powder that may be left outside of the print area. Cure the white ink and adhesive as necessary.

In order to transfer the design to the substrate, place the first surface of the transfer face down on the garment or fabric. Heat is applied to bond the image and transfer it to the garment substrate. Heat press the image at 330 degrees for 10-15 seconds with medium pressure. Peel cold. The design is configured to transfer completely and self-weed any non-printed areas.

The resulting transfer has several unique advantages over traditional transfer methods, such as at least the following: (1) low cost of printing; (2) ease of a single step screening of colored images; (3) printed images sandwiched between layers of plastisol to permit the transfer of multicolored images and self-weeding; (4) low set up time; (5) high quality images to resist cracking, peeling, and fading after washing; and (6) printing of full color images along with specialty plastisol inks.

Use of the present process and transfer paper eliminates hassles that exist with conventional processes and papers. “Patterned” images may be generated within the software and printed as well as different text styles (i.e. wrap text in colorful patterns), specialty styles (i.e. Puff, Glow in the dark, granite, etc.), and simulated embroidery to name a few.

The particular embodiments and method disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A substrate for screen printing, comprising:
a piece of paper configured to accept a digital image; and
a first stage layer applied onto the paper, the first stage layer including:
a plastisol mixture applied onto a surface of the paper; and
a non-adhesive powder configured to coat the plastisol mixture and minimize the tackiness of the surface of the plastisol mixture.

2. The substrate of claim 1, wherein the first stage layer is configured to accept the printing of a digital image.

3. The substrate of claim 1, wherein the plastisol mixture is screen printed onto the paper.

4. The substrate of claim 1, wherein the plastisol mixture includes a predetermined ratio of water reducer and plastisol.

5. The substrate of claim 1, wherein the plastisol mixture uses talc powder to mix plastisol with a water reducer.

6. The substrate of claim 1, wherein the plastisol mixture is flashed at a particular temperature for a selected time duration to cure on the paper.

7. The substrate of claim 1, further comprising:
a digital image printed onto the first stage layer.

8. The substrate of claim 7, wherein the digital image is printed with a pigment based printer.

9. The substrate of claim 7, wherein the digital image contacts the plastisol mixture and passes through the non-adhesive powder.

10. The substrate of claim 9, wherein the surface of the plastisol mixture has an adhesive property such that the digital image partly adheres to the plastisol mixture.

11. The substrate of claim 7, further comprising:
a second stage layer in communication with the digital image, the second stage layer configured to allow for the transfer of the digital image away from the paper.

12. The substrate of claim 11, wherein the second stage layer includes:
a plastisol layer in communication with the digital image and the non-adhesive powder; and
an adhesive powder applied over the plastisol layer.

13. The substrate of claim 12, wherein the adhesive powder is configured to adhere the image during transfer.

14. A method of screen printing, comprising:
printing a digital image onto a transfer paper substrate, the transfer paper substrate including:
a piece of paper;
a plastisol mixture applied over a surface of the paper; and
a non-adhesive powder coated over the plastisol mixture configured to remove adhesive qualities of the plastisol mixture;
applying a layer of plastisol over the digital image and the non-adhesive powder;
covering the plastisol with an adhesive powder configured to assist in the heat transfer of the digital image.

15. The method of claim 14, further comprising:
applying heat to the transfer paper substrate so as to transfer the digital image away from the transfer paper substrate.

16. The method of claim 14, further comprising:
preparing the plastisol mixture by mixing a water reducer and plastisol with a talc powder.

17. The method of claim 14, wherein the digital image is printed with one or more colors.

18. The method of claim 14, wherein the act of transferring the digital image is performed in a single step heat process.
